(19) United States
(12) Patent Application Publication
(10) Pub. No.: US 2009/0040240 A1
(43) Pub. Date: Feb. 12, 2009

(54) Hovering table headers

(76) Inventors: David Kirk Grotjohn, Cary, NC (US); Michael T. Stokes, Raleigh, NC (US)

Correspondence Address: HAMILTON & TERRILE, LLP;IBM RSW, P.O. BOX 203518, AUSTIN, TX, 78720, US

(21) Appl. No.: 11/835,665

(22) Filed: Aug. 8, 2007

(51) Int. Cl. G09G 5/00

(52) U.S. Cl. 345/689

(57) ABSTRACT

A method, system and computer-usable medium are disclosed for displaying header information in a table. One or more cells of a table are selected and their associated header information is determined and replicated. Display attributes are then applied to the replicated header information resulting in the generation of a table header that overlays adjacent table cells. In one embodiment, the resulting table header is dynamically invoked through a user gesture. In another embodiment, the resulting table header is persistently displayed and comprises a viewing window that displays information contained in the selected table cells. The persistent table header moves with the cursor as it is positioned over other table cells and displays the information they contain. Display attributes such as ghosting are applied to other table cells to generate a visually distinguished table header that facilitates visual correlation between selected table cells and their corresponding header information.

### BACKGROUND OF THE INVENTION

1. Field of the Invention

Embodiments of the disclosure relate in general to the field of computers and similar technologies, and in particular to software utilized in this field. Still more particularly, it relates to the display of header information in a table.

2. Description of the Related Art

It is common for many of today's software applications to organize and display data in a tabular format consisting of horizontal rows and vertical columns. This formatted data, generally referred to as a table, is often presented to a user within a character-based or graphical user interface (GUI) on a computer display device such as a monitor or screen. It is also common for the size of the table (i.e., the number of rows and/or columns containing information to be displayed), to exceed the available display space at the zoom level and font size selected by the user. When this is the case, the software application typically allows the user to view a portion of the table, whose full extent exceeds the limits of the display.

Existing approaches include methods that facilitate scrolling, or moving the displayed view of the table over the full extent of the table. For example, GUI windows typically provide vertical and horizontal scroll bars, providing an intuitive graphic means for scrolling the displayed view. Applications that utilize a character-based interface may include commands to scroll the display in vertical and horizontal directions, and may automatically scroll the display when the cursor reaches the edge of the displayed view. As another example, some applications may provide a graphic representation of the full extent of a table, indicating the relative size and current position of the displayed portion of the table by a small rectangle within this extent.

Regardless of the approach, portions of the table may be out of the user's view. This inability to view the entire table can cause usability issues if information in a header describing the contents of a particular cell, row, or column is out of view. As a result, a user is required to scroll up and down or left and right to see the corresponding header information. This is cumbersome and inefficient, as it may cause the user to become disoriented and lose track of not only where they are within the table, but the relevance of the information contained within the cell, row, or column. Prior solutions include designating header rows and columns to be locked such that they remain visible at the edge of the window as the user scrolls the displayed view across the table. However, even with table headers continually displayed, the user is still required to continually scroll cells, rows or columns to keep them in proximity of the headers to reduce the amount of eye movement. Other prior art approaches implement a floating window, invoked by a user gesture such as a mouse hover over a cell, to display each individual cell's headers and contents one-by-one. However, these approaches are inefficient, as they introduce a delay as the information about each cell is displayed. As a result, displaying contextually relevant header information requires the user to either scroll the displayed view of the table, incur disorienting eye movement, or experience delays in hovering over each table cell.

### BRIEF SUMMARY OF THE INVENTION

A method, system and computer-usable medium are disclosed for displaying header information in a table. In various embodiments of the invention, the presence of a table within a computer user interface is detected and one or more cells of the detected table are selected for display of associated header information. For example, a single cell may be selected, a row of cells, a column of cells, or a range of cells comprising entire rows and columns or portions thereof. Once one or more cells have been selected, their associated header information is determined from the existing table headers and then replicated in a dynamic or persistent header.

Display attributes are then applied to the replicated header information. In one embodiment, dynamic display attributes are applied to the replicated header information, and the resulting dynamic table header is manually invoked through a user gesture such as a mouse hover and right-click when the cursor is positioned over the selected cells. In another embodiment, the dynamic table header is automatically invoked through a user gesture such as a mouse hover that positions the cursor over the selected cells. When invoked, the dynamic table header overlays adjacent table cells, but leaves the remaining cells of the table unobscured. If the header information is to be persistently displayed, then persistent display attributes are applied to the replicated header information. In one embodiment, the persistent table header is invoked through a user gesture such as a mouse hover and right-click, and then remains invoked and moves with the cursor as it is positioned over other cells of the table.

In another embodiment, the resulting table header is persistently displayed and comprises a viewing window that displays information contained in the selected table cells. The persistent table header moves with the cursor as it is positioned over other table cells and the window displays the information they contain. In other embodiments, display attributes such as ghosting are applied to other table cells to generate a visually distinguished table header that facilitates visual correlation between selected table cells and their corresponding header information. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a simplified illustration of a dynamic row header as implemented for display within a user interface window in accordance with an embodiment of the invention;

FIG. 3 is a simplified illustration of a dynamic column header as implemented for display within a user interface window in accordance with an embodiment of the invention;

FIG. 4 is a simplified illustration of a persistent column header comprising a viewing window as implemented for display within a user interface window in accordance with an embodiment of the invention;

FIG. 5 is a simplified illustration of a visually distinguished column header with a viewing window as implemented for display within a user interface window in accordance with an embodiment of the invention; and

FIG. 6 is a generalized flowchart of a table header display system as implemented in an embodiment of the invention.

### DETAILED DESCRIPTION

A method, system and computer-usable medium are disclosed for displaying header information in a table. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

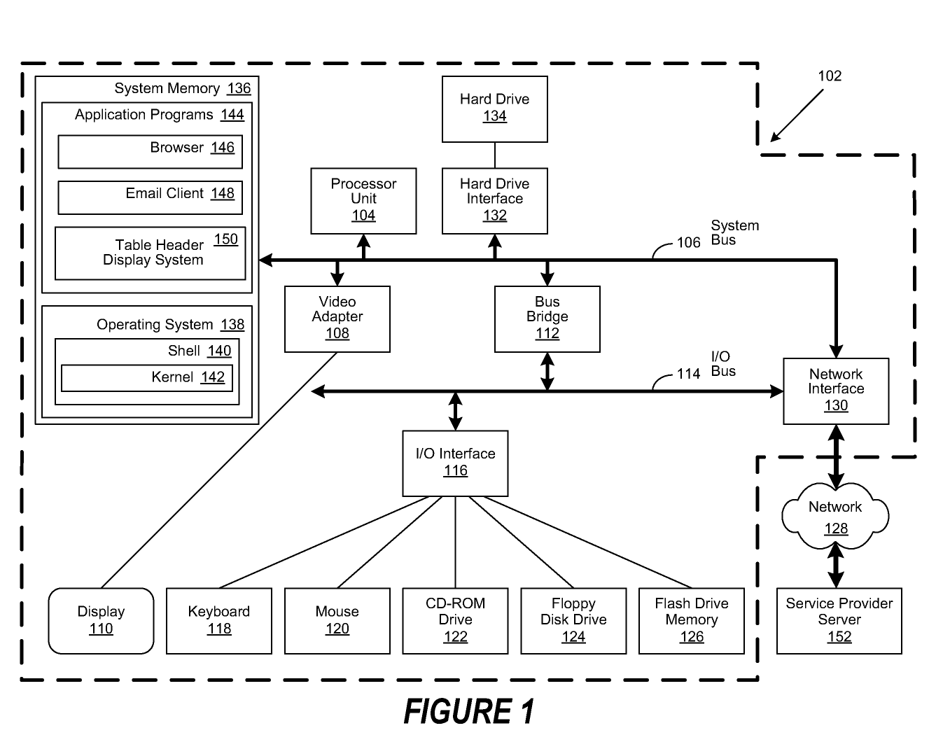

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

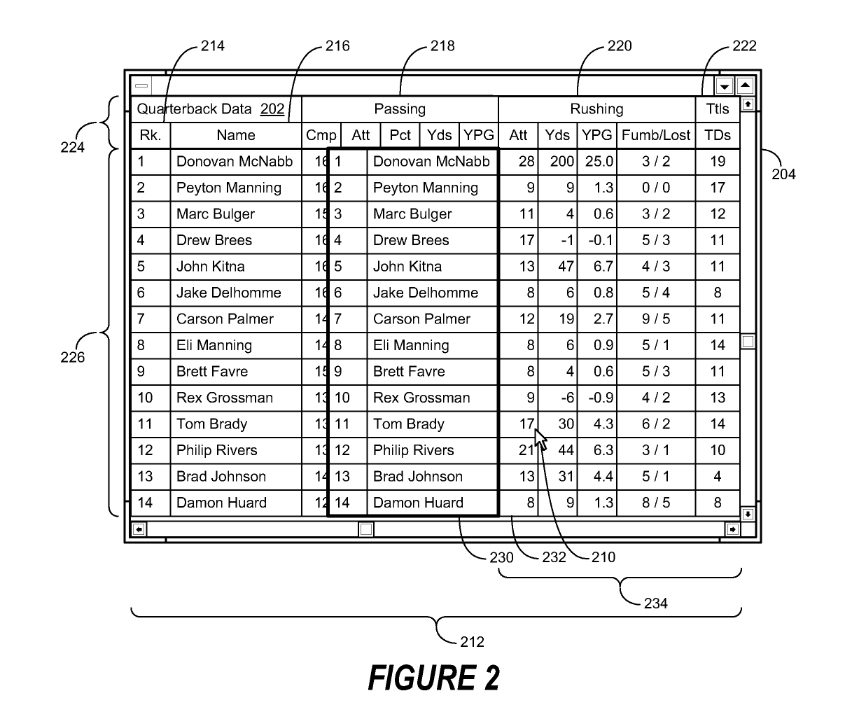

Application programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Application programs 144 also include a table header display system 150. The table header display system 150 includes code for implementing the processes described in FIGS. 2 through 6 described hereinbelow. In one embodiment, client computer 102 is able to download the table header display system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a simplified illustration of a dynamic row header 230 as implemented within a user interface window 204 in accordance with an embodiment of the invention. In this embodiment, quarterback data table 202 comprising information columns 212, static column headers 224, dynamic row header 230, and information rows 226, is displayed in user interface window 204. Static column headers 224 comprise header information “Rank” 216, “Name” 216, and “Passing” 218, further comprising abbreviated subheaders “Completed”, “Attempted”, “Percentage”, “Yards”, and “Yards Per Game”. Static column headers 224 also comprises header information “Rushing” 220, further comprising abbreviated subheaders “Attempted”, “Yards”, “Yards Per Game”, “Fumbled/Lost”, and header information “Total” 222, further comprising abbreviated subheader “Touchdowns”. In general, the information contained in the cells comprising information rows 226 correspond to their respective static column headers 214, 216, 218, 220, 222, and the abbreviated subheaders they comprise.

In one embodiment, dynamic row header 230 replicates the row information contained in static column headers 214 and 216. In another embodiment, the dynamic row header 230 is manually invoked through a user gesture such as a mouse right-click when the cursor 210 is positioned over a predetermined column 232. In yet another embodiment, the dynamic row header 230 is automatically invoked through a user gesture such as a mouse hover that positions the cursor 210 over predetermined column 232. When invoked, the dynamic row header is displayed proximate to predetermined column 232 and overlays adjacent table columns, but leaves the remaining columns 234 of the quarterback data table 202 unobscured. In these and other embodiments, the dynamic row header 230 automatically moves to maintain its positioning relative to whichever column is selected by the user,

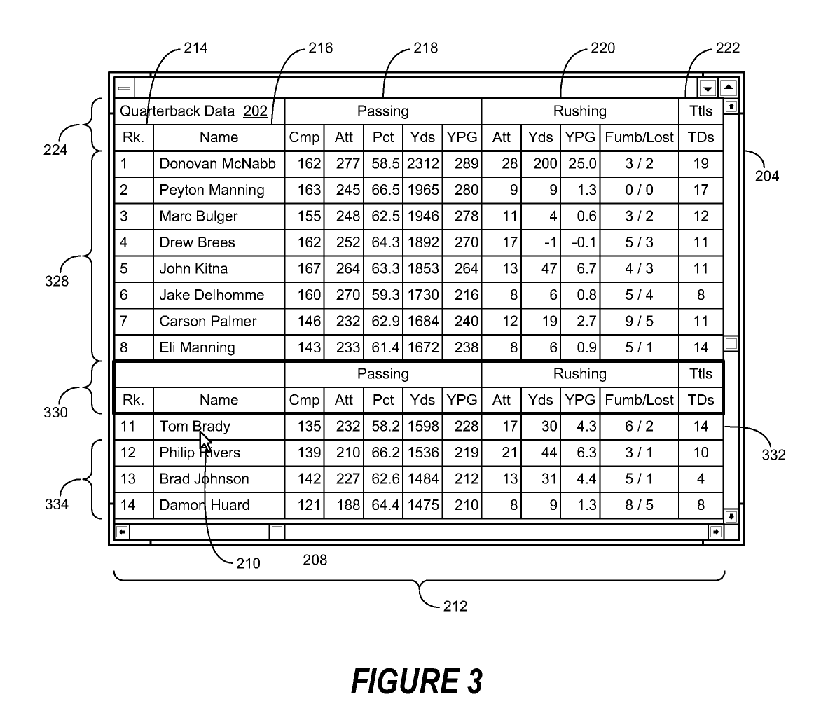

FIG. 3 is a simplified illustration of a dynamic column header 330 as implemented within a user interface window 204 in accordance with an embodiment of the invention. In this embodiment, quarterback data table 202 comprising information columns 212, static column headers 224, dynamic column header 330, and information rows 328, 332, and 334 is displayed within user interface window 204. Static column headers 224 comprise header information “Rank” 216, “Name” 216, and “Passing” 218, further comprising abbreviated subheaders “Completed”, “Attempted”, “Percentage”, “Yards”, and “Yards Per Game”. Static column headers 224 also comprise header information “Rushing” 220, further comprising abbreviated subheaders “Attempted”, “Yards”, “Yards Per Game”, “Fumbled/Lost”, and header information “Total” 222, further comprising abbreviated subheader “Touchdowns”. In general, the information contained in the cells comprising information rows 226 correspond to their respective static column headers 214, 216, 218, 220, 222, and the abbreviated subheaders they comprise.

Dynamic column header 330 replicates the column headers 224 and the abbreviated subheaders they comprise. In one embodiment, the dynamic column header 330 is manually invoked through a user gesture such as a mouse right-click when the cursor 210 is positioned over a predetermined row 332. In another embodiment, the dynamic column header 330 is automatically invoked through a user gesture such as a mouse hover that positions the cursor 210 over predetermined row 332. When invoked, the dynamic column header is displayed proximate to predetermined row 332 and overlays adjacent table rows, but leaves the remaining rows 328, 334 of the quarterback data table 202 unobscured. In these and other embodiments, the dynamic column header 330 automatically moves to maintain its positioning relative to whichever row is selected by the user,

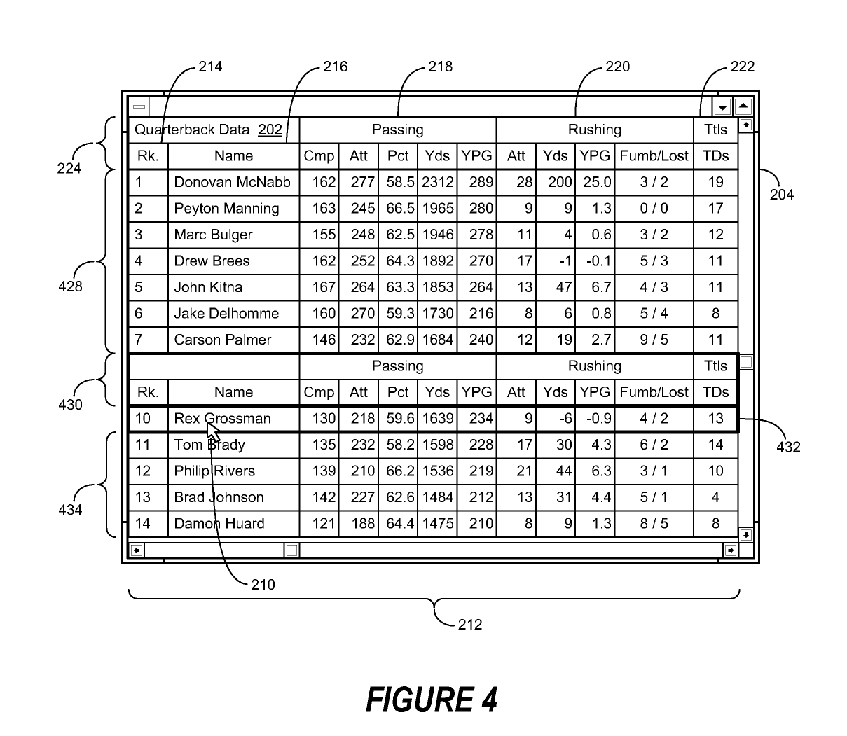

FIG. 4 is a simplified illustration of a persistent column header 430 comprising a viewing window as implemented for display within a user interface window 204 in accordance with another embodiment of the invention. In this embodiment, quarterback data table 202 comprising information columns 212, column headers 224, persistent table header 430, and information rows 428, 432, 434, is displayed within user interface window 204. Static column headers 224 comprise header information “Rank” 216, “Name” 216, and “Passing” 218, further comprising abbreviated subheaders “Completed”, “Attempted”, “Percentage”, “Yards”, and “Yards Per Game”. Static column headers 224 also comprises header information “Rushing” 220, further comprising abbreviated subheaders “Attempted”, “Yards”, “Yards Per Game”, “Fumbled/Lost”, and header information “Total” 222, further comprising abbreviated subheader “Touchdowns”. In general, the information contained in the cells comprising information rows 226 correspond to their respective static column headers 214, 216, 218, 220, 222, and the abbreviated subheaders they comprise.

Persistent column header 430 replicates the column headers 224 and the abbreviated subheaders they comprise. In one embodiment, the persistent column header 430 is manually invoked through a user gesture such as a mouse right-click when the cursor 210 is positioned over predetermined row 432. When invoked, the persistent table header persistently overlays adjacent rows, but leaves the remaining rows 428, 434 of the quarterback data table 202 unobscured. In this embodiment, the persistent column header 430 remains invoked and is moved through a user gesture such as a mouse click-and-drag, or arrow key operation, to position it over other information rows (e.g., 428, 434).

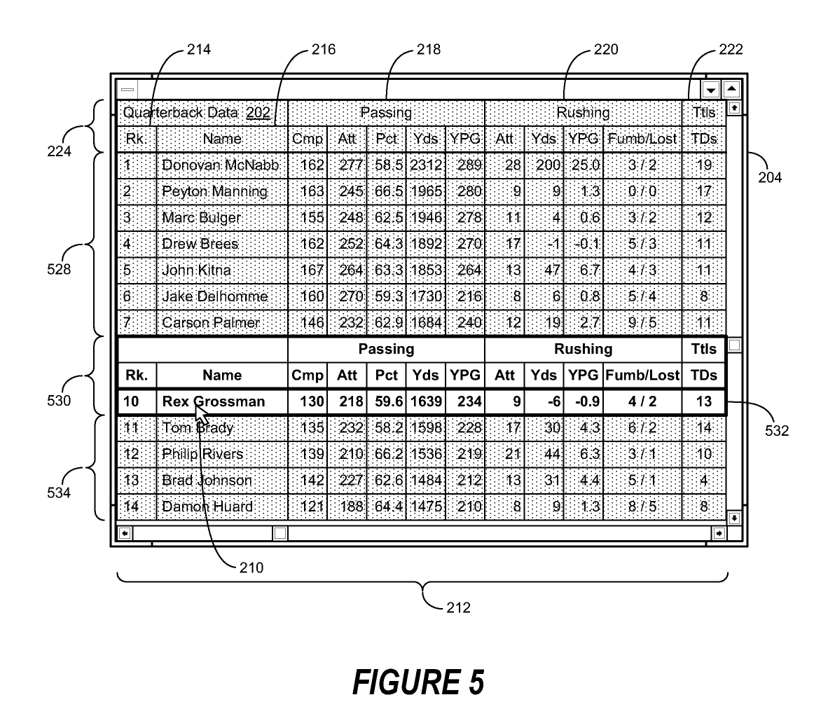

FIG. 5 is a simplified illustration of a visually distinguished column header with a viewing window 530 as implemented for display within a user interface window 204 in accordance with another embodiment of the invention. In this embodiment, quarterback data table 202 comprising information columns 212, column headers 224, visually distinguished table header with viewing window 530, and information rows 528, 532, and 534, is displayed within user interface window 204. Static column headers 224 comprise header information “Rank” 216, “Name” 216, and “Passing” 218, further comprising abbreviated subheaders “Completed”, “Attempted”, “Percentage”, “Yards”, and “Yards Per Game”. Static column headers 224 also comprises header information “Rushing” 220, further comprising abbreviated subheaders “Attempted”, “Yards”, “Yards Per Game”, “Fumbled/Lost”, and header information “Total” 222, further comprising abbreviated subheader “Touchdowns”. In general, the information contained in the cells comprising information rows 226 correspond to their respective static column headers 214, 216, 218, 220, 222, and the abbreviated subheaders they comprise.

Visually distinguished column header with viewing window 530 replicates the column headers 224 and the abbreviated subheaders they comprise. In one embodiment, the visually distinguished table header with viewing window 530 is manually invoked through a user gesture such as a mouse hover and right-click when the cursor 210 is positioned over predetermined row 532. When invoked, the visually distinguished column header with viewing window 530 persistently overlays adjacent rows, but leaves the remaining rows 528, 534 of the quarterback data table 202 unobscured. In various embodiments, the visually distinguished table header with viewing window 530 comprises predetermined display attributes that facilitate visual correlation between predetermined table cells, rows and columns, and their corresponding header information. In one embodiment, the visually distinguished table header with viewing window 530 comprises a viewing window that displays information contained in predetermined table cells, rows and columns. In another embodiment, the visually distinguished table header with viewing window 530 remains invoked and is moved through a user gesture such as a mouse click-and-drag, or arrow key operation, to position it over other predetermined table cells, rows and columns. As the visually distinguished table header with viewing window 530 is moved, it displays the other predetermined table cells, rows and columns in its viewing window. In yet another embodiment, visual attributes are applied to the other predetermined table cells, rows and columns to further facilitate visual correlation. For example, the predetermined table cells, rows and columns may be ghosted to emphasize the visually distinguished table header with viewing window 530.

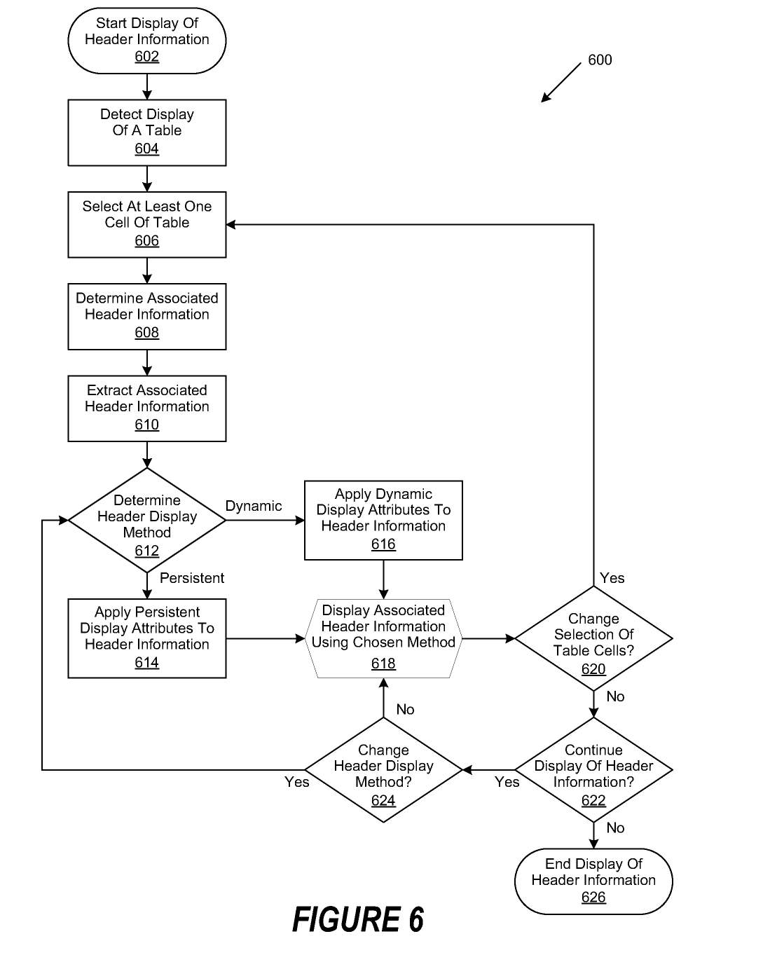

FIG. 6 is a generalized flowchart of a table header display system 600 as implemented in an embodiment of the invention. In various embodiments of the invention, the display of table header information begins in step 602 and the presence of a table within a computer user interface is detected in step 604. In step 606, one or more cells of the detected table are selected for display of associated header information. For example, a single cell may be selected, a row of cells, a column of cells, or a range of cells comprising entire rows and columns or portions thereof. Once one or more cells have been selected, their associated header information is determined in step 608 and then replicated from the existing table headers in step 610.

The method of displaying the replicated header information is then determined in step 612. If it is determined that the header information is to be displayed persistently, then persistent display attributes are applied to the replicated header information in step 614. If it is determined that the header information is to be displayed dynamically, then dynamic display attributes are applied to the replicated header information in step 616. Regardless of the method chosen, the header information associated with the selected cells is displayed in step 618. In one embodiment, the displayed header information is manually invoked through a user gesture such as a mouse hover and right-click when the cursor is positioned over a predetermined cell, row, column, or range of cells. In another embodiment, the displayed header information is automatically invoked through a user gesture such as a mouse hover that positions the cursor over the selected table cells. When invoked, the header information is displayed proximate to the selected table cells and overlays adjacent table cells, but leaves the remaining cells of the table unobscured.

If it is determined in step 620 to change the selection of table cells, then table cells are selected in step 606 and the process continues as before. If it is determined in step 620 to not change the selection of table cells, a determination is made in step 622 whether to continue displaying header information. If it is determined in step 622 to continue displaying header information, then a determination is made in step 624 whether to change the header information display method. If it is determined in step 624 to change the header information display method, then the header information display method is determined in step 612 and the process continues as before. If it is determined in step 624 to not change the header information display method, then the display of header information continues, beginning with step 618. However, if it is determined to discontinue display of header information in step 622, the display of header information is discontinued in step 626.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for displaying header information in a table, comprising:
displaying a portion of a table in a viewable area of a first user interface window, said table comprising a plurality of cells;
selecting a cell in said displayed portion of the table; and
displaying header information associated with said cell in said viewable area at a location proximate to said cell, wherein said header information comprises a plurality of predetermined table attributes.

2. The method of claim 1, wherein a said plurality of associated header information comprises a header row.

3. The method of claim 1, wherein a said plurality of associated header information comprises a header column.

4. The method of claim 1, wherein said plurality of associated header information is persistently displayed in response to said selection of at least one cell.

5. The method of claim 1, wherein said plurality of associated header information is dynamically displayed in response to said selection of at least one cell.

6. The method of claim 1, wherein said selected at least one cell and said plurality of associated header information are displayed in a second user interface window configurable to be visually distinguished from said displayed portion of the table.

7. A system comprising:
a processor;
a data bus coupled to the processor; and
a computer-usable medium embodying computer program code, the computer-usable medium being coupled to the data bus, the computer program code displaying header information in a table and comprising instructions executable by the processor and configured for:
displaying a portion of a table in a viewable area of a first user interface window, said table comprising a plurality of cells;
selecting a cell in said displayed portion of the table; and
displaying header information associated with said cell in said viewable area at a location proximate to said cell, wherein said header information comprises a plurality of predetermined table attributes.

8. The system of claim 7, wherein a said plurality of associated header information comprises a header row.

9. The system of claim 7, wherein a said plurality of associated header information comprises a header column.

10. The system of claim 7, wherein said plurality of associated header information is persistently displayed in response to said selection of at least one cell.

11. The system of claim 7, wherein said plurality of associated header information is dynamically displayed in response to said selection of at least one cell.

12. The system of claim 7, wherein said selected at least one cell and said plurality of associated header information are displayed in a second user interface window configurable to be visually distinguished from said displayed portion of the table.

13. A computer-usable medium embodying computer program code, the computer program code comprising computer executable instructions configured for:
displaying a portion of a table in a viewable area of a first user interface window, said table comprising a plurality of cells; and
selecting a cell in said displayed portion of the table;
displaying header information associated with said cell in said viewable area at a location proximate to said cell, wherein said header information comprises a plurality of predetermined table attributes.

14. The computer usable medium of claim 13 wherein a said plurality of associated header information comprises a header row.

15. The computer usable medium of claim 13, wherein a said plurality of associated header information comprises a header column.

16. The computer usable medium of claim 13, wherein said plurality of associated header information is persistently displayed in response to said selection of at least one cell.

17. The computer usable medium of claim 13, wherein said plurality of associated header information is dynamically displayed in response to said selection of at least one cell.

18. The computer usable medium of claim 13, wherein said selected at least one cell and said plurality of associated header information are displayed in a second user interface window configurable to be visually distinguished from said displayed portion of the table.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.

21. A computer-implementable method for displaying header information in a table, comprising:
displaying a portion of a table in a viewable area of a first user interface window, said table comprising a plurality of cells;
selecting a cell in said displayed portion of the table;
displaying header information associated with said cell in said viewable area at a location first location proximate to said cell, wherein said header information comprises a plurality of predetermined table attributes; and
moving said header information to a second location in said viewable area in response to a user gesture.

22. The method of claim 21, wherein a said plurality of associated header information comprises a header row.

23. The method of claim 21, wherein a said plurality of associated header information comprises a header column.

24. A computer-usable medium embodying computer program code, the computer program code comprising computer executable instructions configured for:
displaying a portion of a table in a viewable area of a first user interface window, said table comprising a plurality of cells;
selecting a cell in said displayed portion of the table;
displaying header information associated with said cell in said viewable area at a location first location proximate to said cell, wherein said header information comprises a plurality of predetermined table attributes; and
moving said header information to a second location in said viewable area in response to a user gesture.

25. The computer usable medium of claim 24 wherein a said plurality of associated header information comprises a header row.

26. The computer usable medium of claim 24, wherein a said plurality of associated header information comprises a header column.
